(19) United States
(12) Patent Application Publication
(10) Pub. No.: US 2015/0143237 A1
(43) Pub. Date: May 21, 2015

(54) IMAGE PROCESSING APPARATUS, IMAGE PROCESSING METHOD AND NON-TRANSITORY COMPUTER-READABLE MEDIUM

(71) Applicant: CANON KABUSHIKI KAISHA, Tokyo (JP)

(72) Inventor: Yukihiro Shindo, Inagi-shi (JP)

(21) Appl. No.: 14/520,427

(22) Filed: Oct. 22, 2014

(30) Foreign Application Priority Data
Nov. 21, 2013 (JP) 2013-241271

(51) Int. Cl. H04N 1/387; G06F 17/21

(52) U.S. Cl. CPC H04N 1/3873; G06F 17/212; H04N 2201/0084
USPC 715/273

(57) ABSTRACT

An image processing apparatus comprises: a first calculation unit which calculates a first parameter for performing distortion correction from a plurality of points located on edges of an object region included in an image; a first correction unit which performs distortion correction of the object region by using the first parameter; a display unit which displays an object region and a plurality of points located on edges of an object region after the correction; an adjustment unit which adjusts positions of the plurality of points; and a second correction unit which, when the adjustment unit adjusts the positions of the plurality of displayed points so as to extend the object region after the correction, performs distortion correction of the extension region by using the first parameter.

### BACKGROUND OF THE INVENTION

1. Field of the Invention

The present invention relates to an image processing apparatus, an image processing method, and a non-transitory computer-readable medium.

2. Description of the Related Art

Recently, there has been a proliferation of mobile terminals having an information processing function and a communication function, such as smartphones and tablets. These mobile terminals generally include cameras and have shooting functions (camera functions). There are increasing chances of shooting a document as a paper medium by using such a camera function and storing and using the shot image as image data in the memory of the mobile terminal.

When storing paper documents upon such camera shooting, the user basically does not shoot from directly in front of the documents, or paper sheets are not held down and hence are not flat unlike in the acquisition of images by a conventional scanner. For this reason, a shot document becomes a distorted image. In addition, the shooting range is not constant, and regions outside documents are also often shot.

Under the circumstances, there is provided application software having a function of simultaneously performing distortion correction using a document frame and trimming processing so as to easily extract only a document range and performing distortion correction in a mobile terminal or the like.

The above application software for performing distortion correction using a document frame and trimming processing is based on the premise that the user accurately designates the position of a document frame (for example, the four corners of a document) before distortion correction/trimming processing. For example, if a designated position is not accurate, end portion data existing in the original image before distortion correction/trimming processing is lost by distortion correction/trimming processing. If the user finds a problem like an end portion loss at the stage of checking after distortion correction/trimming processing, he/she needs to return to the document frame designation screen before distortion correction/trimming processing in order to redo the processing for fine adjustment of the designated position. This leads to an increase in the amount of rework including the designation of a document frame, the recalculation of a distortion amount, and re-correction of the overall image based on the distortion amount. In addition, the user needs to go back in the procedure. That is, this system is poor in usability.

On the other hand, Japanese Patent Laid-Open No. 2005-115711 has proposed a technique in which after the user is allowed to designate coordinate points at the four corners and distortion correction for an overall image is executed, a corrected image is recalculated by adjusting distortion parameters in a longitudinal direction with up and down cursors, and adjusting distortion parameters in a lateral direction with left and right cursors. This technique has an advantage of manually adjusting a distortion correction amount with a proper value after distortion correction and being capable of adjusting the distortion amount again. However, the step size of the proper value used for the adjustment of distortion correction is not decided based on a shooting target. In addition, every time the distortion amount is changed, the overall image is recalculated. For these reasons, fine adjustment is not easy to perform.

The present invention therefore provides a technique of facilitating fine adjustment of a document frame used for distortion correction or trimming processing after distortion correction/trimming processing, with a low recalculation load and high usability.

### SUMMARY OF THE INVENTION

According to one aspect of the present invention, there is provided an image processing apparatus comprising: a specification unit configured to specify a plurality of points located on edges of an object region included in an image; a first calculation unit configured to calculate a first parameter for performing distortion correction from a plurality of points specified by the specification unit; a first correction unit configured to perform distortion correction of the object region by using the first parameter; a display unit configured to display an object region after correction by the first correction unit and a plurality of points located on edges of an object region after the correction; an adjustment unit configured to adjust, based on an instruction from a user, positions of the plurality of points displayed by the display unit; and a second correction unit configured to, when the adjustment unit adjusts the positions of the plurality of displayed points so as to extend the object region after the correction, perform distortion correction of the extension region by using the first parameter, wherein when the adjustment unit adjusts the positions of the plurality of displayed points so as to extend the object region after the correction, the display unit displays the object region after the correction and the extension region after the correction.

According to another aspect of the present invention, there is provided an image processing method comprising: a specification step of specifying a plurality of points located on edges of an object region included in an image; a first calculation step of calculating a first parameter for performing distortion correction from a plurality of points specified in the specification step; a first correction step of performing distortion correction of the object region by using the first parameter; a display step of displaying an object region after correction in the first correction step and a plurality of points located on edges of an object region after the correction; an adjustment step of adjusting, based on an instruction from a user, positions of the plurality of points displayed in the display step; and a second correction step of, when the positions of the plurality of displayed points are adjusted in the adjustment step so as to extend the object region after the correction, performing distortion correction of the extension region by using the first parameter, wherein when the positions of the plurality of displayed points are adjusted in the adjustment step so as to extend the object region after the correction, the object region after the correction and the extension region after the correction are displayed in the display step.

According to another aspect of the present invention, there is provided an non-transitory computer-readable medium storing a program for causing a computer to function as a specification unit configured to specify a plurality of points located on edges of an object region included in an image, a first calculation unit configured to calculate a first parameter for performing distortion correction from a plurality of points specified by the specification unit, a first correction unit configured to perform distortion correction of the object region by using the first parameter, a display unit configured to display an object region after correction by the first correction unit and a plurality of points located on edges of an object region after the correction, an adjustment unit configured to adjust, based on an instruction from a user, positions of the plurality of points displayed by the display unit, and a second correction unit configured to, when the adjustment unit adjusts the positions of the plurality of displayed points so as to extend the object region after the correction, perform distortion correction of the extension region by using the first parameter, wherein when the adjustment unit adjusts the positions of the plurality of displayed points so as to extend the object region after the correction, the display unit updates display by using the object region after the correction and the extension region after the correction.

It is possible to provide a distortion correction/trimming correction unit with high usability.

Further features of the present invention will become apparent from the following description of exemplary embodiments (with reference to the attached drawings).

### BRIEF DESCRIPTION OF THE DRAWINGS

FIGS. 1A and 1B are views each showing the outer appearance of a mobile terminal;

FIGS. 2A and 2B are views each showing an example of a document shooting form in the mobile terminal;

FIG. 3 is a block diagram showing an example of the system configuration of the mobile terminal;

FIG. 4 is a block diagram showing an example of the arrangement of an image processing unit;

FIG. 5 is a flowchart showing control on projective transformation;

FIG. 6 is a view showing an example of an adjustment screen for document frame points (corners) before projective transformation;

FIG. 7 is a view showing an example of a mapping destination information setting screen;

FIG. 8 is a view for explaining the correspondence relationship between an image before projective transformation and an image after projective transformation;

FIGS. 9A, 9B, and 9C are views for explaining the display region of an image;

FIGS. 10A and 10B are views for explaining an example of an adjustment screen for document frame points after projective transformation;

FIGS. 11A, 11B, and 11C are views for explaining the adjustment of document frame points after projective transformation;

FIG. 12 is a view for explaining region division in folding process settings;

FIG. 13 is a view for explaining the correspondence relationship between an image before projective transformation and an image after projective transformation in folding process settings; and

FIG. 14 is a view for explaining margin calculation using the distances between document frame points.

### DESCRIPTION OF THE EMBODIMENTS

The embodiments of the present invention will be described below with reference to the accompanying drawings.

### First Embodiment

### Outer Appearance of Mobile Terminal

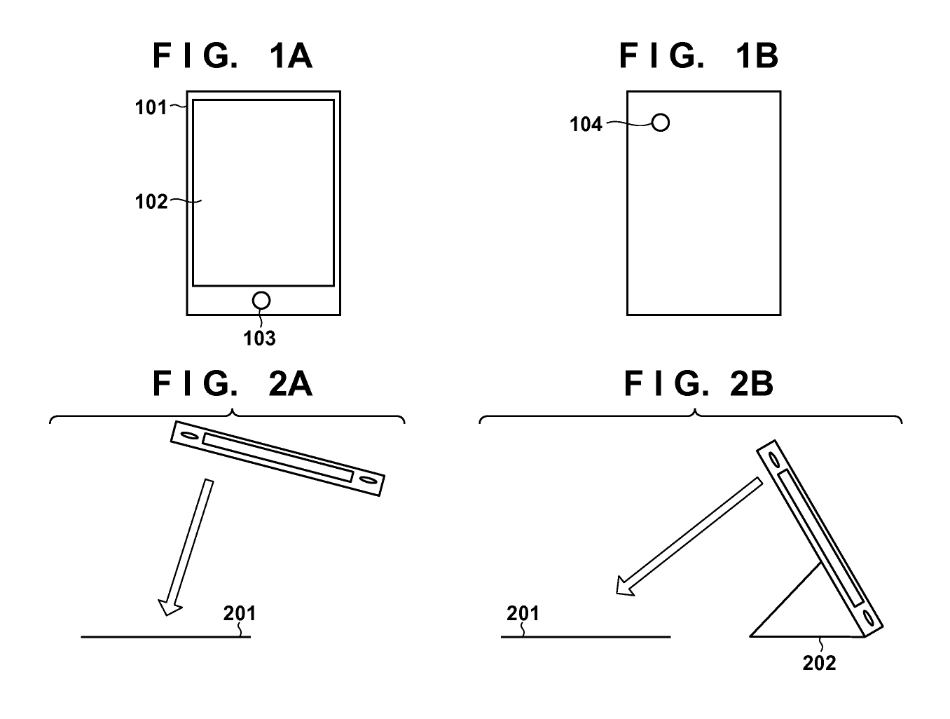

FIGS. 1A and 1B show the outer appearance of a mobile terminal 101 according to this embodiment. Note that the mobile terminal 101 varies in type and arrangement, and is not limited to the arrangement shown in FIGS. 1A and 1B. FIG. 1A shows the upper surface of the mobile terminal 101. The upper surface is provided with a display unit 102 allowing touch operation like a touch panel display and an operation button 103. FIG. 1B shows the lower surface of the mobile terminal 101. A camera 104 is arranged on the lower surface.

Note that the present invention is not limited to a mobile terminal and can be applied to an apparatus which performs distortion correction/trimming processing for the document image shot by an apparatus having a camera function. For example, the present invention may be applied to a system with any of the arrangements of a smartphone, cellular phone, notebook PC, desktop PC, and digital camera.

### Example of Imaging Form of Document Imaging System

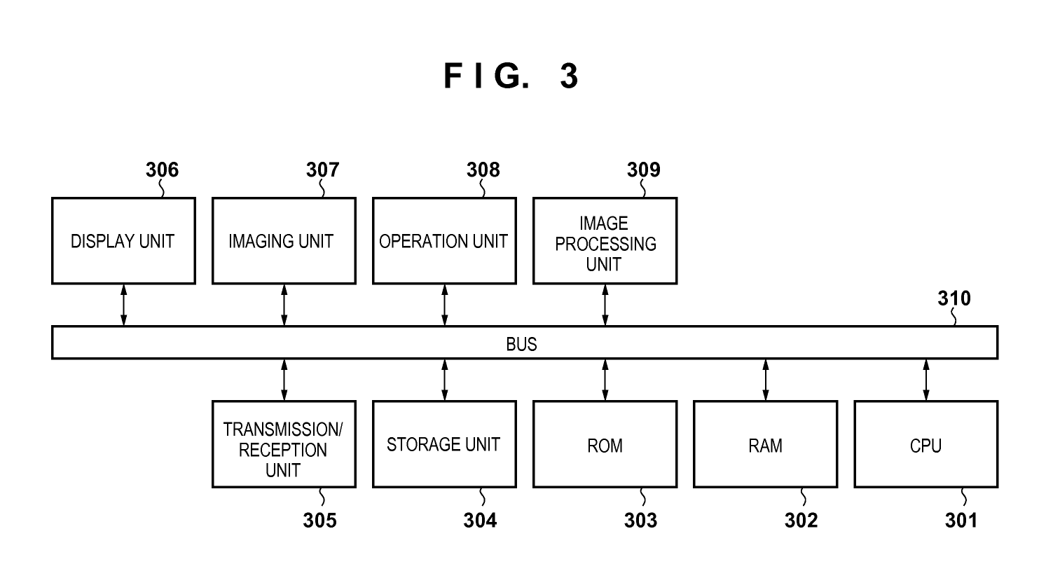

FIGS. 2A and 2B show an example of the imaging form of the mobile terminal 101.

FIG. 2A shows a case in which the user shoots a document 201 from above with the camera 104 while holding the mobile terminal 101 with his/her hand. Note that the camera 104 sometimes has inclinations with respect to a shooting target in the back/forth direction and the right/left direction.

FIG. 2B shows a case in which the mobile terminal 101 is rested on a base 202, and the camera 104 is shooting the document 201. These usages are merely examples and not limited to the examples shown in FIGS. 2A and 2B. For example, the present invention may be applied to a case in which the camera 104 shoots a black board, white board, or bulletin board as a shooting target upon being directed to it.

### Overall System Configuration

FIG. 3 shows an example of the overall system configuration of the mobile terminal 101. Note that this block diagram illustrates only the components necessary for this embodiment. Referring to FIG. 3, a CPU 301, a RAM 302, and a ROM 303 transmit and receive programs and data via a data bus 310. A storage unit 304, a transmission/reception unit 305, a display unit 306, an imaging unit 307, an operation unit 308, and an image processing unit 309 are connected to the data bus 310. The display unit 306 corresponds to the display unit 102 in FIG. 1A. The operation unit 308 receives operation instructions from the user via the display unit 102 capable of touch operation and the operation button 103. The storage unit 304 can store image data and various types of programs. The transmission/reception unit 305 can perform data transmission/reception with respect to a wireless router (not shown). Note that the CPU 301 controls the constituent elements in the mobile terminal 101 based on the programs held in the ROM 303.

### Arrangement of Image Processing Unit

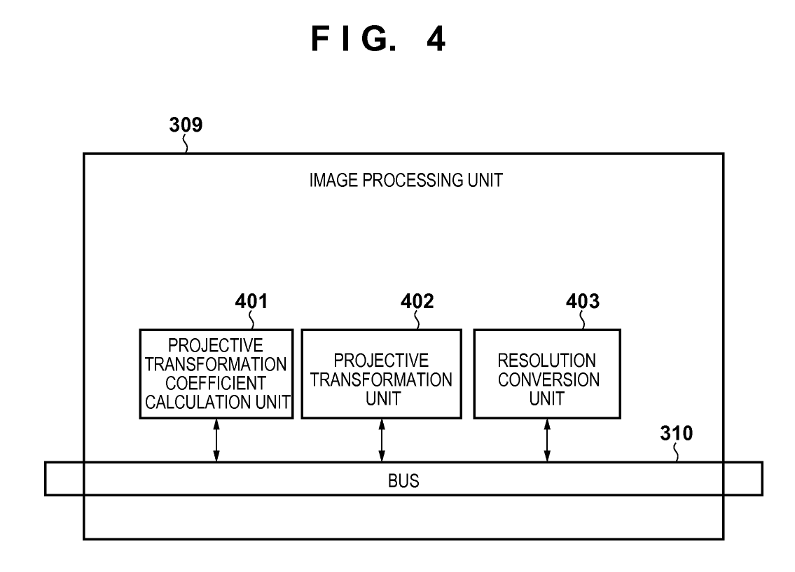

FIG. 4 shows an example of the arrangement of the image processing unit 309. Note that since this block diagram illustrates only the components necessary for this embodiment, the image processing unit 309 may include other constituent elements. The image processing unit 309 includes a projective transformation coefficient calculation unit 401, a projective transformation unit 402, and a resolution conversion unit 403. The projective transformation coefficient calculation unit 401, the projective transformation unit 402, and the resolution conversion unit 403 respectively transmit and receive programs and data via the data bus 310. The projective transformation coefficient calculation unit 401 calculates projective transformation coefficients by providing the coordinate data of four points before and after projective transformation. The projective transformation unit 402 performs matrix transformation by using the projective transformation coefficients calculated by the projective transformation coefficient calculation unit 401 to obtain a projective transformation image. The resolution conversion unit 403 performs arbitrary resolution conversion upon designation of an input/output resolution, a size, and a magnification.

### Projective Transformation Processing Procedure

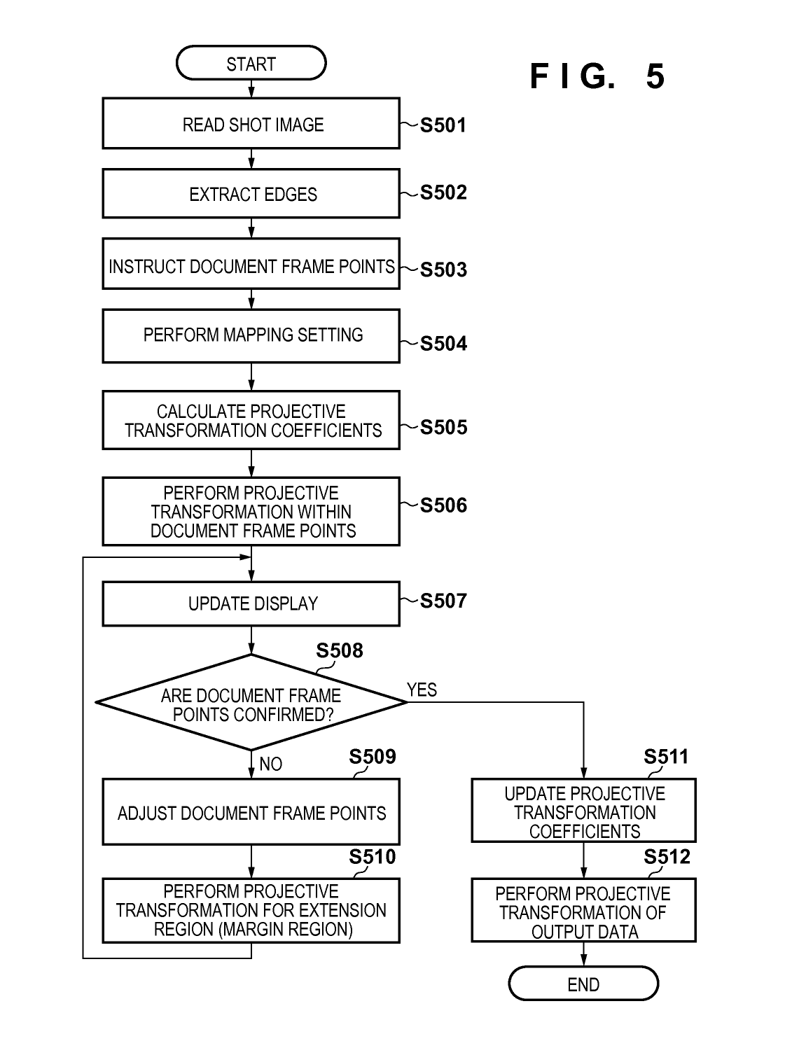

FIG. 5 shows an example of a projective transformation procedure in the present invention. Assume that the CPU 301 implements this procedure by executing this flowchart based on a program stored in the ROM 303. Note that the RAM 302 is used as a buffer to be used at the time of image processing. Assume that output data after image processing based on the flowchart is stored in the storage unit 304 or transmitted to a printer (not shown) via the transmission/reception unit 305.

In step S501, the CPU 301 activates the camera 104 to shoot the document 201 or reads the image obtained by shooting the document 201, which is stored in the RAM 302. If the resolution of the read image is higher than a predetermined value, the resolution conversion unit 403 may convert the resolution into an arbitrary low resolution. In step S502, the CPU 301 extracts edges from the read image. For example, the CPU 301 performs edge extraction by performing image processing using an edge detection algorithm based on the Canny method. Note that the present invention can use a known edge extraction method and is not limited to any specific method. It is possible to omit edge extraction in this step and acquire information concerning edges or four corner points directly designed by the user.

In step S503, the CPU 301 detects and specifies document frame points (corners) at the four corners located on the edges from the extracted edge information. If the detection accuracy is insufficient or no edge can be detected, the operation unit 308 which has received a user instruction via the display unit 102 capable of touch operation performs coordinate adjustment of document frame points (corners) at the four corners. FIG. 6 shows a state in which the operation unit 308 is receiving an instruction concerning coordinate information of document frame points (corners) P1 to P4 at the four corners on the preview image displayed on the display unit 102 capable of touch operation. The following description will be made on the assumption that a shooting target is a document, and a region indicating the document is a document region (object region).

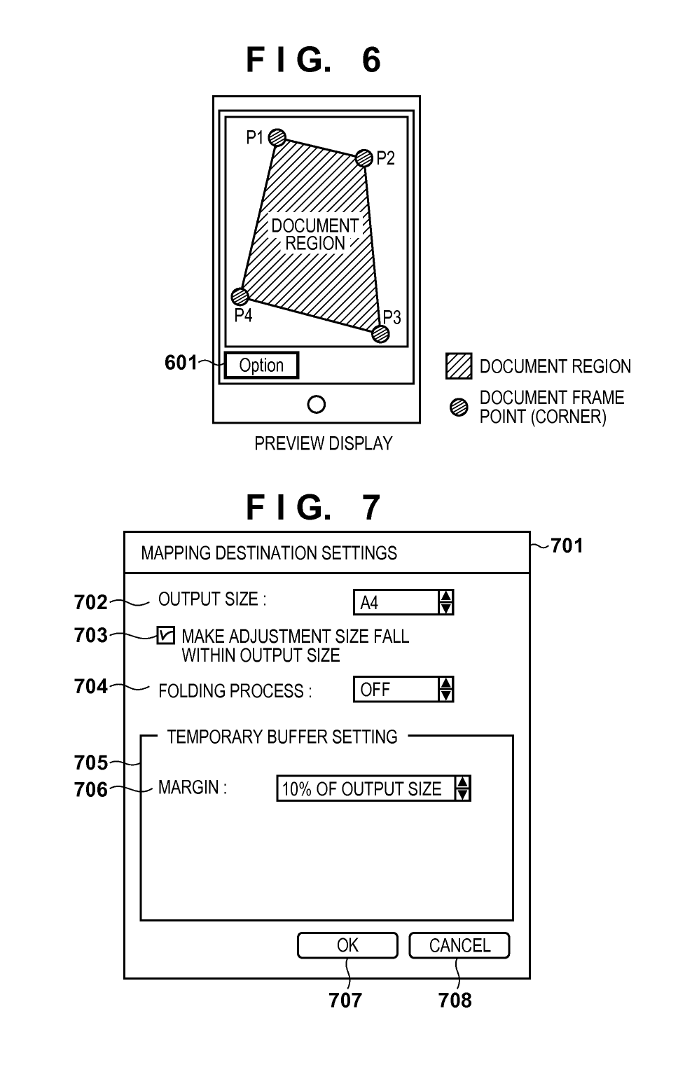

In step S504, the CPU 301 sets information concerning a mapping destination after projective transformation of the document frame points (corners) decided in step S503. FIG. 7 shows a mapping destination setting screen 701 to be displayed when an Option button 601 shown in FIG. 6 is pressed. Selecting an output size from the list (A0, . . . , A4, . . . , B0, . . . , B4, . . . , and the like) indicated by an output size 702 will decide basic corresponding points of document frame points P1 to P4. Note that it is possible to add an arbitrary size of an indefinite form as an output side to the list indicated by the output size 702. In this case, an output size corresponds to a paper size when, for example, the printer outputs.

In addition to the setting of the output size 702, a margin 706 is set in a temporary buffer setting 705 used for mapping setting for a temporary buffer (the RAM 302 in this case). The temporary buffer setting 705 is used as margin information for deciding margins based on a shooting target. This function is one of the features of the present invention. With the margin 706, the user selects an arbitrary designated ratio with respect to an output size from the list. Although described in detail later, providing a margin region around a document region in the temporary buffer makes it possible to easily handle document frame adjustment after projective transformation. Note that in this embodiment, the same set value is used with respect to an output size in the vertical and horizontal directions. However, the present invention is not limited to this. For example, with the margin 706, it is possible to make different settings in the vertical and horizontal directions.

In this embodiment, the size of the temporary buffer and the mapping destinations of the document frame points (corners) P1 to P4 are determined by using the output size and margin amount set on the mapping destination setting screen 701. Note that a checkbox 703 is used to instruct, upon adjustment document frame points (lines) (to be described later), whether to set the range after the adjustment as an output size. This operation will be described in detail later. Other settings of the margin 706 and settings of a folding process 704 will be described in the second and third embodiments. In the first embodiment, the mapping destination setting screen 701 shown in FIG. 7 implements a receiving unit.

In step S505, the CPU 301 causes the projective transformation coefficient calculation unit 401 to calculate projective transformation coefficients to be stored in the temporary buffer based on the coordinate information of the document frame points (corners) P1 to P4 decided in step S503 and the mapping settings decided in step S504. Note that each step after step S505 will be described in detail after the description of this procedure.

In step S506, the CPU 301 executes projective transformation (distortion correction/trimming processing) for the image within the document frame points (corners) on the preview image by using the projective transformation coefficients calculated by the projective transformation unit 402 in step S505.

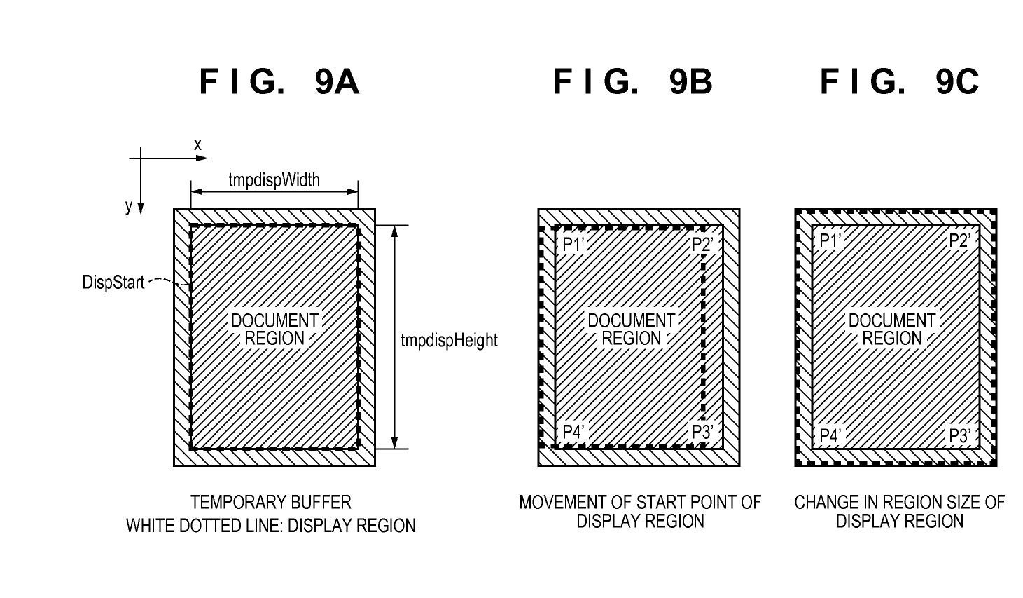

In step S507, the CPU 301 updates the display content on the display unit 102 into a preview image based on the result of performing distortion correction/trimming processing by projective transformation in step S506. Note that the display on the display unit 102 is executed by storing the display range in the temporary buffer into the display buffer (not shown) of the display unit 306. Note that if the display unit 102 differs in resolution from the display range in the temporary buffer, the resolution conversion unit 403 performs resolution conversion to convert the resolution into the one matching the display unit 102. Thereafter, the display unit 102 performs display. This operation will be described in detail with reference to FIGS. 9A to 9C.

In step S508, the CPU 301 determines whether document frame points are confirmed. If it is determined that the image having undergone distortion correction/trimming processing by projective transformation displayed on the display unit 102 is the one desired by the user and document frame points are determined based on user instructions (YES in step S508), the process advances to step S511. If it is determined that document frame points are not confirmed, upon receiving, for example, a user instruction to perform fine adjustment in accordance with the occurrence of an end portion loss or the like caused by trimming (NO in step S508), the process advances to step S509.

In step S509, the CPU 301 adjusts the document frame points on the image after correction, whose display has been updated in step S507, based on user instructions and the like, and avoids image loss arising from trimming, and fine adjustment of a distortion correction position.

In step S510, when the document frame points are adjusted from the original positions toward the extension side in step S509, the CPU 301 performs projective transformation with respect to the regions secured as margins by using the projective transformation coefficients obtained by the projective transformation unit 402 in step S505. The process then returns to step S507, in which the CPU 301 updates the display. Note that projective transformation for the region within the document frame points in step S506 is defined as the first correction, and projective transformation with respect to an extension region (margin region) in step S510 is defined as the second correction. The corrected image obtained by the first correction is combined with the image obtained by the second correction to update the display by using the composite image. Note that when the document frame points are adjusted from the original positions toward the reduction side in step S509, the image of the reduced portion may be deleted from the corrected image obtained by the first correction to update the display in step S507.

If the document frame points are determined (YES in step S508), the CPU 301 causes the projective transformation coefficient calculation unit 401 to calculate projective transformation coefficients in accordance with the adjustment result on the document frame points, thereby updating the projective transformation coefficients in step S511. Note that the projective transformation coefficients calculated in step S505 are defined as the first parameters, and the projective transformation coefficients calculated in step S511 are defined as the second parameters.

In step S512, the CPU 301 performs projective transformation for generating a final output image with respect to the document region desired by the user which is included in the read image by using the projective transformation coefficients updated by the projective transformation unit 402 in step S511.

[Calculation of Projective Transformation Coefficients]

The projective transformation coefficient calculation in step S505 will be described in detail. In this embodiment, projective transformation coefficients are parameters for performing distortion correction for a document region.

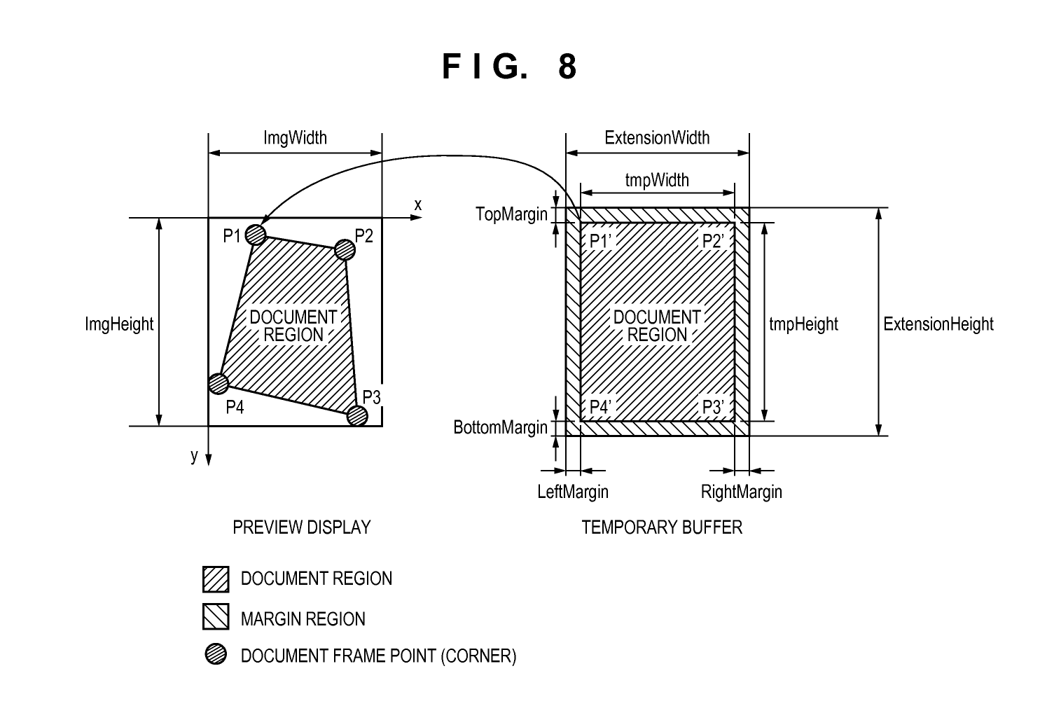

FIG. 8 shows document frame points (corners) at the four corners of a preview image which are instructed in step S503, and the mapping destination in the temporary buffer which is set in step S504 and to which data after projective transformation is made to correspond. Assume that in the following description, the upper left end is defined as the origin of the coordinate system. In addition, the lateral and longitudinal directions of the screen are respectively defined as the X- and Y-axes.

Coordinate data can represent coordinates before and after transformation in the following manner. In this case, let P be coordinates before transformation, and P′ be coordinates after transformation.

P1(x1,y1) [symbol] P1′(x1′,y1′)=P1′(LeftMargin,TopMargin)

P2(x2,y2) [symbol] P2′(x2′,y2′)=P2′(LeftMargin+tmpWidth,TopMargin)

P3(x3,y3) [symbol] P3′(x3′,y3′)=P3′(LeftMargin+tmpWidth,TopMargin+tmpHeight)

P4(x4,y4) [symbol] P4′(x4′,y4′)=P4′(LeftMargin,TopMargin+tmpHeight)

As described above, a feature of the present invention is that a margin region is provided on the assumption that information outside the frame is calculated, while four points as document frame points (corners) are designated, and a projective transformation matrix is calculated by using a mapping relationship. Assume that a margin region indicates a region in a predetermined range from each edge of the document to an outside.

Note that a document region (tmpWidth, tmpHeight) in the temporary buffer corresponds to an aspect ratio based on “A4 size” set with the output size 702. In addition, since this region is a preview display in the process of deciding a final projective transformation matrix, a resolution of about 72 dpi is sufficient. In this case,

(tmpWidth,tmpHeight)=(595,847)[pix]

In addition, it is possible to obtain a margin amount in accordance with “10% margin of output size” set with the margin 706. Assume that in this case, the margin amount is a value which is obtained by dropping the fractional portion and is divisible by 2.

TopMargin=BottomMargin=0.10*tmpHeight≈84[pix]

LeftMargin=RightMargin=0.10*tmpWidth≈58[pix]

As described above, the size of the temporary buffer is given by

ExtensionWidth,ExtensionHeight)=(tmpWidth+LeftMargin+RightMargin,tmpHeight+TopMargin+BottomMargin)

=(595+58*2,847+84*2)=(711,1015)[pix]

In addition, mapping coordinates P1′, P2′, P3′, and P4′ after projective transformation are given by

P1′(x1′,y1′)=P1′(LeftMargin,TopMargin)=(58,84)

P2′(x2′,y2′)=P2′(LeftMargin+tmpWidth,TopMargin)=(653,84)

P3′(x3′,y3′)=P3′(LeftMargin+tmpWidth,TopMargin+tmpHeight)=(653,931)

P4′(x4′,y4′)=P4′(LeftMargin,TopMargin+tmpHeight)=(58,931)

Since the coordinates of the document frame points (corners) before projective transformation have been decided in step S503, projective transformation coefficients (planar projective transformation coefficients) can be obtained from four sets of coordinates before and after projective transformation. For example, when the read image has 1200×1600 [pix], document frame point coordinates are given below

P1(x1,y1)=(200,50)

P2(x2,y2)=(1100,200)

P3(x3,y3)=(50,1400)

P4(x4,y4)=(1150,1500)

Note that in order to obtain projective transformation coefficients, z-axis information is added to the coordinate data to handle P(x, y) as P(x, y, 1), and calculation is performed as follows.

$$\begin{matrix}{sP}^{′} = H \cdot P \\ H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] & ( 1 ) \\ [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}x \\ y \\ 1\end{matrix} ] = [ \begin{matrix}{sx}^{′} \\ {sy}^{′} \\ s\end{matrix} ] & ( 2 )\end{matrix}$$

where s is a scale, H is a nomography matrix, P is pre-projective transformation coordinates, and P′ is post-projective transformation coordinates.

In this case, although intermediate expressions are omitted, equation (2) is arranged into equation (3).

$$[ \begin{matrix}x & y & 1 & 0 & 0 & 0 & - {xx}^{′} & - {yx}^{′} \\ 0 & 0 & 0 & x & y & 1 & - {xy}^{′} & - {yy}^{′}\end{matrix} ] [ \begin{matrix}{h}_{11} \\ {h}_{12} \\ {h}_{13} \\ {h}_{14} \\ {h}_{15} \\ {h}_{16} \\ {h}_{17} \\ {h}_{18}\end{matrix} ] = [ \begin{matrix}{x}^{′} \\ {y}^{′}\end{matrix} ] \qquad ( 3 )$$

In this case, solving the simultaneous equations by substituting the coordinate information of four sets of corresponding points will obtain coefficients of H. More specifically, the following state is obtained by substituting the information of the four sets of corresponding points.

$$[ \begin{matrix}{x}_{1} & {y}_{1} & 1 & 0 & 0 & 0 & - {x}_{1} {x}_{1}^{′} & - {y}_{1} {x}_{1}^{′} \\ 0 & 0 & 0 & {x}_{1} & {y}_{1} & 1 & - {x}_{1} {y}_{1}^{′} & - {y}_{1} {y}_{1}^{′} \\ {x}_{2} & {y}_{2} & 1 & 0 & 0 & 0 & - {x}_{2} {x}_{2}^{′} & - {y}_{2} {y}_{2}^{′} \\ 0 & 0 & 0 & {x}_{2} & {y}_{2} & 1 & - {x}_{2} {y}_{2}^{′} & - {y}_{2} {y}_{2}^{′} \\ {x}_{3} & {y}_{3} & 1 & 0 & 0 & 0 & - {x}_{3} {x}_{3}^{′} & - {y}_{3} {x}_{3}^{′} \\ 0 & 0 & 0 & {x}_{3} & {y}_{3} & 1 & - {x}_{3} {y}_{3}^{′} & - {y}_{3} {y}_{3}^{′} \\ {x}_{4} & {y}_{4} & 1 & 0 & 0 & 0 & - {x}_{4} {x}_{4}^{′} & - {y}_{4} {x}_{4}^{′} \\ 0 & 0 & 0 & {x}_{4} & {y}_{4} & 1 & - {x}_{4} {y}_{4}^{′} & - {y}_{4} {y}_{4}^{′}\end{matrix} ] [ \begin{matrix}{h}_{11} \\ {h}_{12} \\ {h}_{13} \\ {h}_{14} \\ {h}_{15} \\ {h}_{16} \\ {h}_{17} \\ {h}_{18}\end{matrix} ] = [ \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ {x}_{4}^{′} \\ {y}_{4}^{′}\end{matrix} ]$$

When the resultant data are arranged for each matrix, A·H=B, and H is an unknown quantity. Applying the inverse matrix of A to the two sides of the equation will obtain

H=A⁻¹·B

The following is an example of obtaining H by arranging the above data and mathematical expressions.

TABLE 1

| P: Pre-projective Transformation | | |
|---|---|---|
| Coordinates | x | y |
| P1 | 200 | 50 |
| P2 | 1100 | 200 |
| P3 | 50 | 1400 |
| P4 | 1150 | 1500 |

TABLE 2

| P′: Post-projective Transformation | | |
|---|---|---|
| Coordinates | x′ | y′ |
| P1′ | 58 | 84 |
| P2′ | 653 | 84 |
| P3′ | 653 | 931 |
| P4′ | 58 | 931 |

$$A = [ \begin{matrix}200 & 50 & 1 & 0 & 0 & 0 & - 11600 & - 2900 \\ 0 & 0 & 0 & 200 & 50 & 1 & - 16800 & - 4200 \\ 1100 & 200 & 1 & 0 & 0 & 0 & - 718300 & - 130600 \\ 0 & 0 & 0 & 1100 & 200 & 1 & - 92400 & - 16800 \\ 50 & 1400 & 1 & 0 & 0 & 0 & - 32650 & - 914200 \\ 0 & 0 & 0 & 50 & 1400 & 1 & - 46550 & - 1303400 \\ 1150 & 1500 & 1 & 0 & 0 & 0 & - 66700 & - 87000 \\ 0 & 0 & 0 & 1150 & 1500 & 1 & - 1070650 & - 1396500\end{matrix} ]$$

$$B = [ \begin{matrix}58 \\ 84 \\ 653 \\ 64 \\ 653 \\ 931 \\ 58 \\ 931\end{matrix} ]$$

Therefore, obtaining H=A⁻¹·B will produce

$$inverseA = [ \begin{matrix}0 & 0 & 0 & 0 & 0 & 0 & - 1.26622 * {10}^{- 4} & - 9.33766 * {10}^{- 4} \\ 0 & 0 & 0 & 0 & 0 & 0 & 8.38044 * {10}^{- 4} & 6.2862 * {10}^{- 4} \\ 1.22 & 0.17 & - 0.2 & - 0.2 & 0 & - 0.1 & - 1.5366219 * {10}^{- 2} & 1.43970993 * {10}^{- 1} \\ 0 & 0 & 0 & 0 & 0 & 0 & - 1.98891 * {10}^{- 4} & - 2.59254 * {10}^{- 4} \\ 0 & 0 & 0 & 0 & 0 & 0 & 1.192762 * {10}^{- 3} & 1.015547 * {10}^{- 3} \\ 0 & 1.22 & 0.02 & - 0.2 & 0.02 & 0 & - 1.8105243 * {10}^{- 2} & - 1.5366219 * {10}^{- 2} \\ 0 & 0 & 0 & 0 & 0 & 0 & - 2.12365 * {10}^{- 7} & - 1.25704 * {10}^{- 6} \\ 0 & 0 & 0 & 0 & 0 & 0 & 1.26723 * {10}^{- 6} & 1.11397 * {10}^{- 6}\end{matrix} ]$$

The inverse matrix of H is obtained and substituted into

P=H⁻¹·P′

This makes it possible to obtain information indicating the pixel values of specific coordinates of the preview image which should be referred to for the pixel values of all the coordinates constituting the temporary buffer in FIG. 8 and to perform projective transformation. Note that in this case, priority is given to the intelligibleness of a time-series process, and the expression written above is the one for obtaining an inverse transformation from the inverse matrix of the homography matrix of transforming P into P′. This method, however, takes much effort to obtain an inverse matrix, because H is not an nth-degree square matrix. In practice, since inverse transformation is also projective transformation, it suffices to inverse the relationship between P and P′.

### (Method 1)

Letting P be pre-projective transformation coordinates and P′ be post-projective transformation coordinates, a homography matrix H1 of P′=H1·P is obtained.

### (Method 2)

Letting P′ be pre-projective transformation coordinates and P be post-projective transformation coordinates, a homography matrix H2 of P=H2·P′ is obtained.

The viewpoint of method 1 described above is changed to that of method 2 to back-calculate the coordinates of P from P′. This obviates the necessity to obtain an inverse matrix required for back calculation in method 1. In the above description, the expressions to be used are switched. However, substituting the coordinate data of P into P′, and the coordinate data of P′ into P will obviate the necessity to change the expression to be used. Table 3 corresponds to Table 1, and Table 4 corresponds to Table 1.

TABLE 3

| P: Pre-projective Transformation | | |
|---|---|---|
| Coordinates | x | y |
| P1 | 58 | 84 |
| P2 | 653 | 84 |
| P3 | 653 | 931 |
| P4 | 58 | 931 |

TABLE 4

| P′: Post-projective Transformation | | |
|---|---|---|
| Coordinates | x′ | y′ |
| P1′ | 200 | 50 |
| P2′ | 1100 | 200 |
| P3′ | 50 | 1400 |
| P4′ | 1150 | 1500 |

Therefore, obtaining H=A⁻¹·B will produce

$$H = [ \begin{matrix}0.691132 \\ - 0.53571 \\ - 55.5748 \\ 0.138636 \\ - 0.85878 \\ 96.12199 \\ 0.000207 \\ - 0.00157\end{matrix} ] = [ \begin{matrix}0 & 0 & 0 & 0 & 0 & 0 & - 1.26622 * {10}^{- 4} & - 9.33766 * {10}^{- 4} \\ 0 & 0 & 0 & 0 & 0 & 0 & 8.38044 * {10}^{- 4} & 6.2862 * {10}^{- 4} \\ 1.22 & 0.17 & - 0.2 & - 0.2 & 0 & - 0.1 & - 1.5366219 * {10}^{- 2} & 1.43970993 * {10}^{- 1} \\ 0 & 0 & 0 & 0 & 0 & 0 & - 1.98891 * {10}^{- 4} & - 2.59254 * {10}^{- 4} \\ 0 & 0 & 0 & 0 & 0 & 0 & 1.192762 * {10}^{- 3} & 1.015547 * {10}^{- 3} \\ 0 & 1.22 & 0.02 & - 0.2 & 0.02 & 0 & - 1.8105243 * {10}^{- 2} & - 1.5366219 * {10}^{- 2} \\ 0 & 0 & 0 & 0 & 0 & 0 & - 2.12365 * {10}^{- 7} & - 1.25704 * {10}^{- 6} \\ 0 & 0 & 0 & 0 & 0 & 0 & 1.26723 * {10}^{- 6} & 1.11397 * {10}^{- 6}\end{matrix} ] \cdot [ \begin{matrix}58 \\ 84 \\ 653 \\ 64 \\ 653 \\ 931 \\ 58 \\ 931\end{matrix} ]$$

[Projective Transformation within Document Frame Points]

The projective transformation within the document frame points in step S506 will be described in detail below. The respective pixel values in the temporary buffer in FIG. 8 are obtained by performing projective transformation using the projective transformation coefficients obtained in step S505. At this time, since a margin region is unnecessary unless fine adjustment is performed for document frame points, projective transformation is performed first for a region other than the margin region (that is, the image region within the document frame points). Note that projective transformation may be performed for the margin region on the background within the range in which no influence is exerted on the display performance after projective transformation is performed for the image region within the document frame points.

[Display Update]

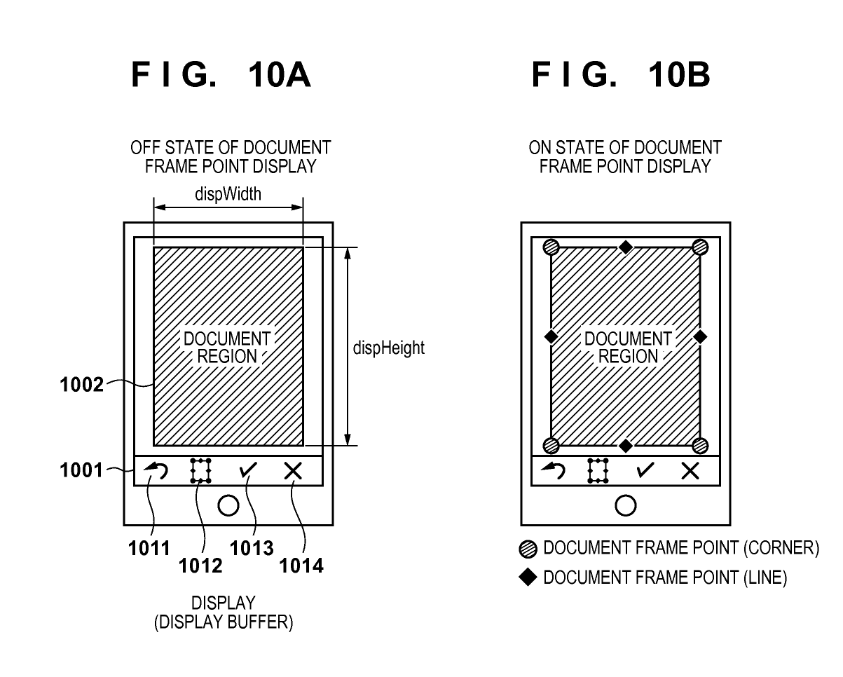

The display update in step S507 will be described in detail below. FIGS. 9A to 9C each show the display region used for display in the temporary buffer by the black dotted line. As shown in FIG. 9A, the display region has a start point (initial phase) DispStart and a region size (tmpdispWidt, tmpdispHeight). In this case, the default size is equal to the output size. As shown in FIGS. 9B and 9C, changing the start point and the region size can change the display range of the image displayed in an image display region 1002 of the display unit 102 shown in FIG. 10A. Note that the size (dispWidth, dispHeight) of the image display region 1002 in FIG. 10A sometimes differs from the display region size (tmpdispWidth, tmpdispHeight) in the temporary buffer. Assume that the display unit 102 performs processing for the adjustment of this difference, and a detailed description of the processing will be omitted. For example, since a magnification can be obtained from an initial phase and a size ratio, the resolution conversion unit 403 may perform resolution conversion in accordance with either the vertical or horizontal size of the image display region 1002, and the display unit 102 may display the result.

[Document Frame Point Adjustment]

The document frame point adjustment in step S509 will be described in detail below. FIGS. 10A and 10B each show the state of the display unit 102 after projective transformation. The display unit 102 shows an operation button area 1001 and the image display region 1002. The operation button area 1001 is provided with a return button 1011, a document frame point display button 1012, a document frame point confirm button 1013, and a cancel button 1014.

The user operates the return button 1011 to issue an instruction to return to the immediately preceding step. When the user issues an instruction by operating the return button 1011, the processing is redone from the processing (step S503) of adjusting the positions of the document frame points (corners) in a state before projective transformation. The screen shown in FIG. 6 then appears. The user operates the document frame point display button 1012 to issue an instruction to ON/OFF-switch the display of the document frame points, and an instruction to adjust the document frame points in an ON state. FIG. 10A shows an OFF state, and FIG. 10B shows an ON state. The display unit 102 is displayed in an ON state as a default state.

The user operates the document frame point confirm button 1013 to issue an instruction to confirm document frame points on a preview image and execute projective transformation with a formal image size by using the document frame point information. The user operates the cancel button 1014 to issue an instruction to cancel projective transformation of a target image.

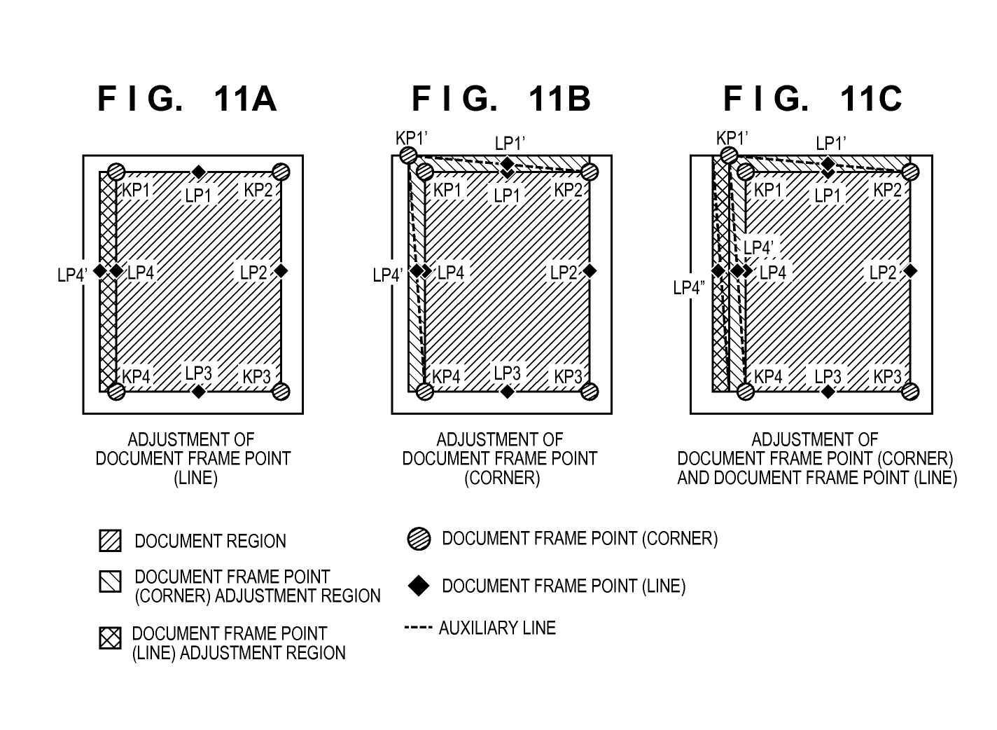

The adjustment of the document frame points shown in FIG. 10B will be described next. Document frame points (lines) are generated as intermediate points connecting document frame points (corners). Moving the document frame points (lines) can adjust the trimming range. Assume that in this case, it is possible to adjust the vertical lines of the frame only in the x-axis direction and to adjust the horizontal lines of the frame only in the y-axis direction. In addition, adjusting document frame points (lines) will not change the display positions of document frame points (corners). When performing adjustment, only auxiliary lines indicating the trimming range are changed. This operation will be described later with reference to FIGS. 11A to 11C. In addition, moving document frame points (corners) can adjust distortion and a trimming range. In this embodiment, however, a distortion amount is not recalculated on a preview screen. In addition, adjusting the document frame points (corners) will change the intermediate points between the document frame points (corners). For this reason, reference positions without any adjustment on the document frame points (lines) are moved in synchronism with the adjustment of the document frame points (corners).

FIGS. 11A to 11C show the movement of document frame points and the states of trimming auxiliary lines when the above document frame points (corners) and document frame points (lines) are adjusted. Referring to FIGS. 11A to 11C, each document frame point (corner) is represented by KP, and each document frame point (line) is represented by LP. FIG. 11A shows a case in which a document frame point (line) LP4 is adjusted into LP4′ on the extension side. Although this adjustment has no influence on the document frame points (corners), the trimming range is extended to the portion expressed by the tile pattern.

FIG. 11B shows a case in which a document frame point (corner) KP1 is adjusted into KP1′ on the extension side. Along with this adjustment, the display positions of document frame points (lines) LP1 and LP4 are changed to LP1′ and LP4′, respectively. In addition, while the hatched portion is extended as a display range, the auxiliary lines connecting the document frame points (corners) indicating the trimming range are updated. FIG. 11C shows how a combination change is performed when the document frame point (line) LP4′ is adjusted to LP4″ after the document frame point (corner) KP1 is changed to KP1′. Assume that in this embodiment, a document region is extended such that at least part of a portion held as a margin region is included in the document region.

[Projective Transformation of Extension Region (Margin Region)]

The projective transformation of an extension region in step S510 will be described in detail below. The tile pattern and hatched portions in FIGS. 11A to 11C correspond to a margin region in the temporary buffer, and the pixel values of this portion are obtained by applying projective transformation coefficients obtained in advance. Note that the pixel values of a margin region may be obtained on the background before the reception of an instruction to adjust document frame points.

Obtaining projective transformation coefficients by using a buffer having a margin region in this manner makes it possible to process only a portion for which an instruction is issued to newly perform display, when performing frame point adjustment with respect to an image after projective transformation, by using the same projective transformation coefficients (that is, the projective transformation coefficients used when the first projective transformation is performed). This makes it possible to handle such an instruction with high responsiveness.

The process then returns to step S507 again to update the display. At this time, the display range changes in accordance with the setting of the checkbox 703 in FIG. 7. Based on the setting of the checkbox 703, ON/OFF control is performed whether to make an adjustment size fall within an output size. If the checkbox 703 is ON, the adjustment of the document frame points in step S509 makes the entire region within the document frame points fall within the output size. Referring to FIGS. 11A to 11C, the tile pattern and hatched regions newly obtained by document frame point adjustment and the document region fall within the display range. That is, the scale of the display size is changed in accordance with the aspect ratio of the output size. If the checkbox 703 is OFF, control is performed to shift the display position toward the adjusted document frame points while maintaining the original display size, as shown in FIG. 9B.]

The processing to be performed when the document frame points are confirmed in step S508 will be described in detail next.

[Update of Projective Transformation Coefficients]

The update of the projective transformation coefficients in step S511 will be described in detail below. When a document frame point is adjusted in step S509, the coordinates of the adjusted document frame point (corner) before projective transformation are obtained, and projective transformation coefficients are recalculated by using the coordinate point. Note that the mapping destination coordinates and the output image size are changed in accordance with document frame points (lines) and the ON/OFF state of the checkbox 703.

If the checkbox 703 is ON, the output image size is changed in the following manner. When, for example, the document frame point (line) LP4 is adjusted by lp4_ax in the x-axis direction, the scale is adjusted to set tmpWidth+lp4_ax as an output size. In addition, the margin amount is adjusted by using the scale.

scaleW=tmpWidth/(tmpWidth+lp4_{—}ax)

LeftMargin=lp4_{—}ax*scaleW

TopMargin=BottomMargin=RightMargin=0

tmpWidth=tmpWidth*scaleW(dstWidth,dstHeight)

=(tmpWidth+LeftMargin+RightMargin,tmpHeight+TopMargin+BottomMargin)

P1′(x1′,y1′)=P1′(LeftMargin,TopMargin)

P2′(x2′,y2′)=P2′(LeftMargin+tmpWidth,TopMargin)

P3′(x3′,y3′)=P3′(LeftMargin+tmpWidth,TopMargin+tmpHeight)

P4′(x4′,y4′)=P4′(LeftMargin,TopMargin+tmpHeight)

If the checkbox 703 is OFF, calculation is performed with the scale being 1 (S=1), and the output size varies in accordance with the adjustment of document frame points.

[Projective Transformation of Output Data]

The projective transformation of the output data in step S512 will be described in detail below. Projective transformation is executed for a region decided as a read image output target (the region within the document frame points) by using the final projective transformation coefficients obtained in step S511.

As described above, in the first embodiment, it is possible to easily adjust document frame points on an image after projective transformation by ensuring a buffer having a margin region and using projective transformation coefficients.

### Second Embodiment

The first embodiment has exemplified the method of facilitating the adjustment of document frame points on an image after projective transformation by ensuring a buffer having a margin region and using projective transformation coefficients. The second embodiment has a feature that when a document is a folded document and projective transformation is applied to the document upon division, it is possible to apply document frame point adjustment to an image after projective transformation by applying projective transformation upon also dividing a margin region.

The following is a case in which twofold is selected from a list of folding processes 704 in FIG. 7 (twofold, threefold, and fourfold). If twofold is selected, the number of document frame points to be designated by the user is increased to 6. Assume that newly added document frame points on the folded portion in this case are defined as document frame points (fold). Note that the number of document frame points (fold) varies in accordance with the set value of the folding process 704. In addition, document frame points (fold) are basically arranged at equal intervals from document frame points (corners), as shown in FIG. 12. However, the positions of document frame points (fold) at the mapping destination may be adjusted by predetermined settings.

Referring to FIG. 12, each document point (fold) is represented by OP. In FIG. 12, A′_Height=tmpHeight/2. With this setting, the temporary buffer at the mapping destination including a margin region is divided into regions. In the case shown in FIG. 12, the buffer is divided into surfaces A′ and B′ at the position of TopMargin+A′_Height on the Y-coordinate axis.

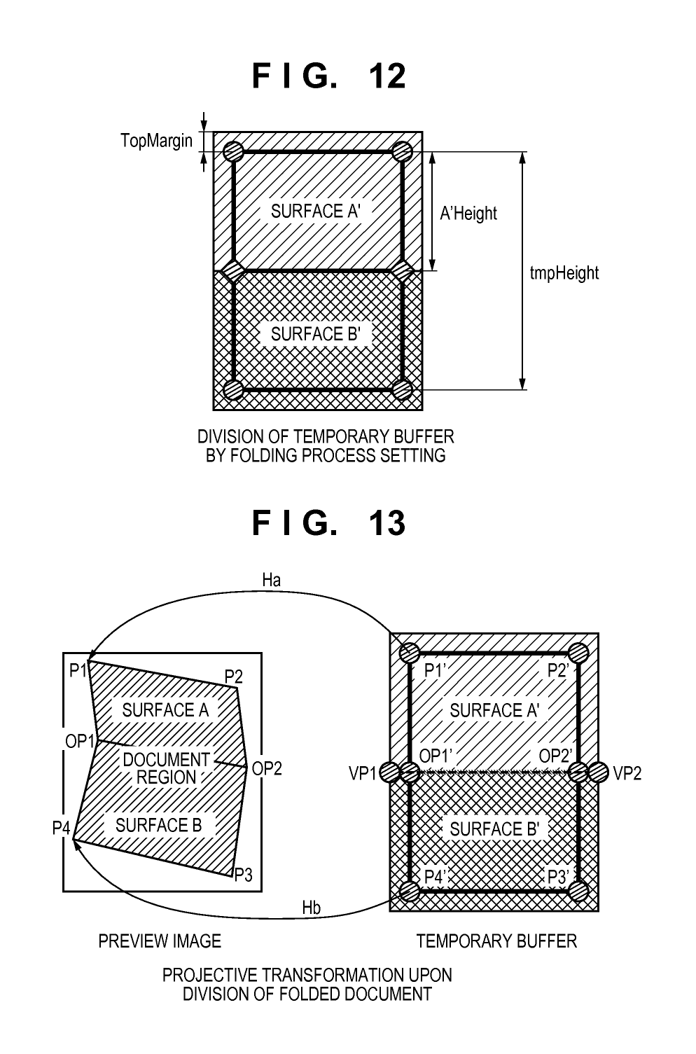

FIG. 13 shows a state in which projective transformation is separately applied to surfaces A and B of the twofold document. The projective transformation coefficients Ha and Hb for the respective surfaces are obtained by using points P1, P2, OP2, and OP1 on the surface A, points OP1, OP2, P3, and P4 on the surface B, and corresponding points at the mapping destination.

Pixel values within the surface A′ including the margin region are calculated by using Ha, and pixel values within the surface B′ are calculated by using Hb. With this operation, pixel values in the margin region are calculated in accordance with projective transformation coefficients on the respective surfaces with respect to a document divided into regions, thereby easily coping with the adjustment of document frame points corresponding to an image after projective transformation. Note that document frame points (fold) can be adjusted in the same manner as for document frame points (corners). Note, however, that the manner of dividing the temporary buffer into regions is not basically changed regardless of the adjustment of document frame points (fold).

If a region is to be changed by the adjustment of document frame points (fold), virtual points VP1 and VP2 are set by extending the straight line connecting points OP1′ and OP2′ as the mapping destinations of document frame points (fold). The overall temporary buffer including the margin region is divided into the surfaces A′ and B′ at the straight line connecting VP1 and VP2.

In the second embodiment, a temporary buffer including a margin region is divided into regions, and pixel values belonging to the respective regions are calculated by using projective transformation coefficients obtained on the respective region surfaces. This makes it possible to adjust document frame points on an even folded document after projective transformation, which has a plurality of projective transformation matrices. Note that in this embodiment, it is determined, based on the set value of the folding process 704, whether division is performed. However, the present invention is not limited to this. For example, edges may be extracted to determine, from the state of the edges, whether to perform division.

### Third Embodiment

The first embodiment has exemplified the method of facilitating the adjustment of document frame points on an image after projective transformation by ensuring a buffer having a margin region and using projective transformation coefficients. In this case, a margin region is decided by a ratio to an output size.

The third embodiment has a feature that a margin region is decided from the resolution of a display image.

When visually adjusting document frame points on a display unit 102, errors greatly change depending on in which scale a display image is displayed. In this embodiment, a maximum scale is obtained from a resolution dispimg_resolution of a display image by frame line projective transformation, and a margin is decided from the scale.

If, for example, it is assumed that a visual error of about 10 mm occurs on a display image of dispimg_resolution=72[dpi], an error of about (10 [mm]/25.4 [mm])*72 [dot]=28 [pix] is assumed.

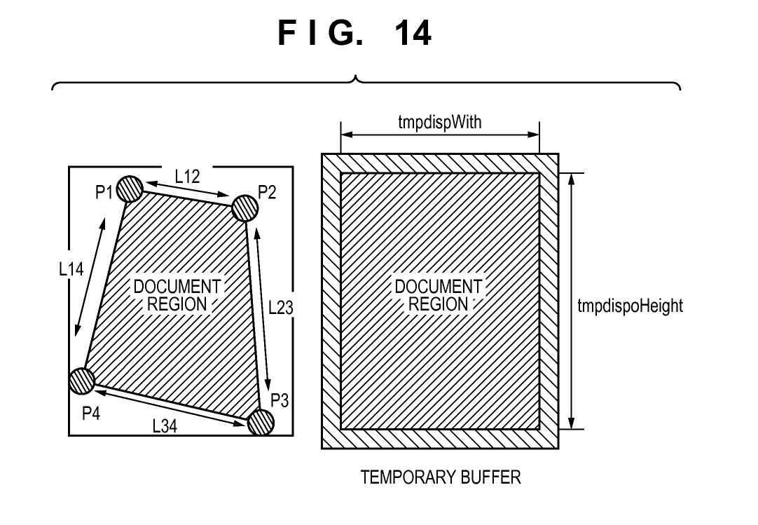

When performing projective transformation like that shown in FIG. 14, the distances between the respective points with the resolution of the display image, that is, document frame points (corners) P1, P2, P3, and P4, are given as |L12|, |L23|, |L34|, and |L14|. In this case, |X| represents the absolute value of X. The scales of the respective lines are obtained as

S12=tmpdispWidth/|L12|

S23=tmpdispHeight/|L23|

S34=tmpdispWidth/|L34|

S14=tmpdispHeight/|L14|

The size of the margin region is then given as 28 [pix]×Smax, where Smax is the largest scale of the above scales.

With the above operation, a margin region can be decided in accordance with a display state. This makes it possible to prevent a wastefully large margin region from being ensured or an adjustment range from being insufficient because of a lack in margin.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-241271, filed Nov. 21, 2013, which is hereby incorporated by reference herein in its entirety.

What is claimed is:

1. An image processing apparatus comprising:
a specification unit configured to specify a plurality of points located on edges of an object region included in an image;
a first calculation unit configured to calculate a first parameter for performing distortion correction from a plurality of points specified by said specification unit;
a first correction unit configured to perform distortion correction of the object region by using the first parameter;
a display unit configured to display an object region after correction by said first correction unit and a plurality of points located on edges of an object region after the correction;
an adjustment unit configured to adjust, based on an instruction from a user, positions of the plurality of points displayed by said display unit; and
a second correction unit configured to, when said adjustment unit adjusts the positions of the plurality of displayed points so as to extend the object region after the correction, perform distortion correction of the extension region by using the first parameter,
wherein when said adjustment unit adjusts the positions of the plurality of displayed points so as to extend the object region after the correction, said display unit displays the object region after the correction and the extension region after the correction.

2. The apparatus according to claim 1, further comprising:
a second calculation unit configured to calculate a second parameter for performing distortion correction from the plurality of points adjusted by said adjustment unit in response to confirmation of adjustment of the plurality of points by said adjustment unit; and
a generation unit configured to generate an output image by performing distortion correction of a region, of the image, which is indicated by the plurality of points adjusted by said adjustment unit by using the second parameter.

3. The apparatus according to claim 1, further comprising a setting unit configured to set a margin region around an object region corrected by said first correction unit,
wherein when said adjustment unit adjusts the positions of the plurality of points displayed by said display unit so as to extend the positions within the margin region based on an instruction from a user, said second correction unit performs distortion correction of the extension region by using the first parameter.

4. The apparatus according to claim 1, wherein the distortion correction comprises projective transformation.

5. The apparatus according to claim 1, wherein said first calculation unit calculates the first parameter from a plurality of points specified by said specification unit and an output size when an output image is output.

6. The apparatus according to claim 5, further comprising a receiving unit configured to receive a setting of the output size.

7. The apparatus according to claim 6, wherein said receiving unit further receives a setting of a size of the margin region as a ratio to the output size.

8. The apparatus according to claim 1, further comprising a unit configured to decide a size of the margin region based on a resolution of the image.

9. The apparatus according to claim 6, further comprising an image display unit configured to display an image obtained by being corrected by said first correction unit and said second correction unit.

10. The apparatus according to claim 9, wherein when displaying the image obtained by being corrected by said first correction unit and said second correction unit, said image display unit displays the image so as to make the image fall within an aspect ratio of an output size received by said receiving unit.

11. The apparatus according to claim 1, further comprising a dividing unit configured to divide the object region included in the image,
wherein said first calculation unit calculates a first parameter for each region divided by said dividing unit.

12. The apparatus according to claim 11, further comprising a folding process receiving unit configured to receive information concerning a folding process for an object in the object region,
wherein said dividing unit decides a region to be divided based on the information concerning the folding process.

13. The apparatus according to claim 1, wherein the object region includes a document region included in the image.

14. An image processing method comprising:
a specification step of specifying a plurality of points located on edges of an object region included in an image;
a first calculation step of calculating a first parameter for performing distortion correction from a plurality of points specified in the specification step;
a first correction step of performing distortion correction of the object region by using the first parameter;
a display step of displaying an object region after correction in the first correction step and a plurality of points located on edges of an object region after the correction;
an adjustment step of adjusting, based on an instruction from a user, positions of the plurality of points displayed in the display step; and
a second correction step of, when the positions of the plurality of displayed points are adjusted in the adjustment step so as to extend the object region after the correction, performing distortion correction of the extension region by using the first parameter,
wherein when the positions of the plurality of displayed points are adjusted in the adjustment step so as to extend the object region after the correction, the object region after the correction and the extension region after the correction are displayed in the display step.

15. A non-transitory computer-readable medium storing a program for causing a computer to function as
a specification unit configured to specify a plurality of points located on edges of an object region included in an image,
a first calculation unit configured to calculate a first parameter for performing distortion correction from a plurality of points specified by the specification unit,
a first correction unit configured to perform distortion correction of the object region by using the first parameter,
a display unit configured to display an object region after correction by the first correction unit and a plurality of points located on edges of an object region after the correction,
an adjustment unit configured to adjust, based on an instruction from a user, positions of the plurality of points displayed by the display unit, and
a second correction unit configured to, when the adjustment unit adjusts the positions of the plurality of displayed points so as to extend the object region after the correction, perform distortion correction of the extension region by using the first parameter,
wherein when the adjustment unit adjusts the positions of the plurality of displayed points so as to extend the object region after the correction, the display unit updates display by using the object region after the correction and the extension region after the correction.
